(19) United States
(12) Patent Application Publication
(10) Pub. No.: US 2010/0283608 A1
(43) Pub. Date: Nov. 11, 2010

(54) Intrusion Warning and Reporting Network

(75) Inventors: Mark D. Asplund, Albuquerque, NM (US); Marshall Henrie, Albuquerque, NM (US); David C. Baughman, Albuquerque, NM (US); Jason H. Penley, Keller, TX (US); William J. Klein, Stillwater, NM (US)

Correspondence Address: HONEYWELL/SLW;Patent Services, 101 Columbia Road, P.O. Box 2245, Morristown, NJ, 07962-2245, US

(73) Assignee: HONEYWELL INTERNATIONAL INC., Morristown, NJ (US)

(21) Appl. No.: 11/968,812

(22) Filed: Jan. 3, 2008

Related U.S. Application Data
(60) Provisional application No. 60/878,778, filed on Jan. 4, 2007.

(51) Int. Cl. G08B 13/00

(52) U.S. Cl. 340/541

(57) ABSTRACT

A system for detection of intrusions and reporting those intrusions, including a plurality of sensors, the plurality of sensors providing a corresponding plurality of detection outputs to a remote controller, the remote controller operative to receive at least one of the plurality of detection outputs and to provide a high speed output indication of intrusion presence.

### RELATED APPLICATIONS

The present patent application claims priority under 35 U.S.C. §119(e) to U.S. Provisional Patent Application Ser. No. 60/878,778, which was filed Jan. 4, 2007. The full disclosure of U.S. Provisional Patent Application Ser. No. 60/878,778 is incorporated herein by reference.

### FIELD

The present invention relates generally to intrusion detection and warning. More particularly, the present invention relates to a network-based intrusion warning and reporting system and method.

### BACKGROUND

Security systems are typically deployed in homes and commercial buildings to prevent theft, damage, and injury to persons within the buildings. These systems typically include various alarm components which communicate to a central controller. Once one of these alarm components, such as a sensor, detects an intrusion, a transmitter associated with the sensor transmits signals to the central controller. The central controller then alerts a user that an intrusion has occurred. The central controller may alert a user of an intrusion via the user's cell phone. The central controller traditionally alerts a user by either a vibration, a repeating noise, or a simple visual, such as a flashing light.

However, the surveillance networks currently available do not provide the information desired for applications such as a hostile military environment. In a military application, it is not sufficient to merely be alerted of an intrusion into an area under surveillance, a user also needs to know location information of the intrusion. With location information, the intruder can be properly tracked and caught, if necessary. This location information is desirable and beneficial for other applications as well, such as home security, industrial security, and the protection of penitentiaries.

It is highly desirable to provide a new and improved network for providing remote supervision of intrusions. It is thus highly desirable to provide a new and improved communication network between a plurality of sensors at different locations and a controller, where the network utilizes a plurality of sensory displays, signals and prompts to supervise and report intrusions and intrusion information at spaced remote locations.

### SUMMARY

The present invention overcomes many of the disadvantages of the prior art by providing an intrusion warning and reporting network designed to detect intrusions in the area, to inform users monitoring the area when an intrusion has occurred, and to inform the users of the location of the intrusion.

The intrusion detection and reporting network includes one or more sensors and a remote controller. A user will associate the sensors with the controller to form a radio network. The user will place the sensors, before being associated with the controller, in areas where intrusion detection is desired.

When a sensor detects an intrusion, an appropriate signal is transmitted to the controller via the radio network. A display associated with the controller allows the user to view details concerning the intrusion. These details may include information regarding the time and location of the intrusion, and they may be communicated visually, aurally, and/or haptically.

The display may be an interactive display, where the user can select screen options from an initial screen. The screen options may be, for example, an alert screen, an add sensor screen, a command screen, or a network status screen. The alert screen may show information regarding the last alert and allow the user to further select an image screen to view images of an intrusion. The add sensor screen allows the user to add more sensors to the network. The command screen allows the user to change the status of a sensor; a sensor could be set to a number of different modes. For example, the sensor could be either active or inactive, depending on whether the particular area within which the sensor is placed requires surveillance. A network status screen may provide the user with information regarding the mode set for each sensor, the amount of battery remaining in each sensor, as well as the type of sensor. If the sensor is, or includes, an imaging sensor, recorded visual images may be transmitted to and shown on the display. In addition, the controller may inform the user of an intrusion with any one of numerous types of annunciators, such as a vibration annunciator.

The controller may be housed within a computer, such as a laptop or desktop computer. The controller may also be housed within a personal digital assistant, or a wrist-mountable device.

The intrusion detection and reporting network may have many practical applications. For example, the intrusion detection and reporting network can be applied to military, home, industrial, corporate, neighborhood, or penitentiary use.

### BRIEF DESCRIPTION OF THE DRAWINGS

Various embodiments are described herein with reference to the following drawings. Certain aspects of the drawings are depicted in a simplified way for reason of clarity. Not all alternatives and options are shown in the drawings and, therefore, the invention is not limited in scope to the content of the drawings. In the drawings:

FIG. 1 is a functional block diagram of an intrusion detection and reporting system according to one embodiment of the present invention;

FIG. 2 depicts an embodiment of a wrist-mountable controller;

FIG. 3 depicts an embodiment of FIG. 1 wherein sensors of the intrusion detection and reporting system are planted in series;

FIG. 4 depicts various functions that may be implemented by a controller in the system of FIG. 1; and

FIG. 5 depicts various user interface screens that may be displayed on a display screen of the controller of FIG. 4.

### DETAILED DESCRIPTION

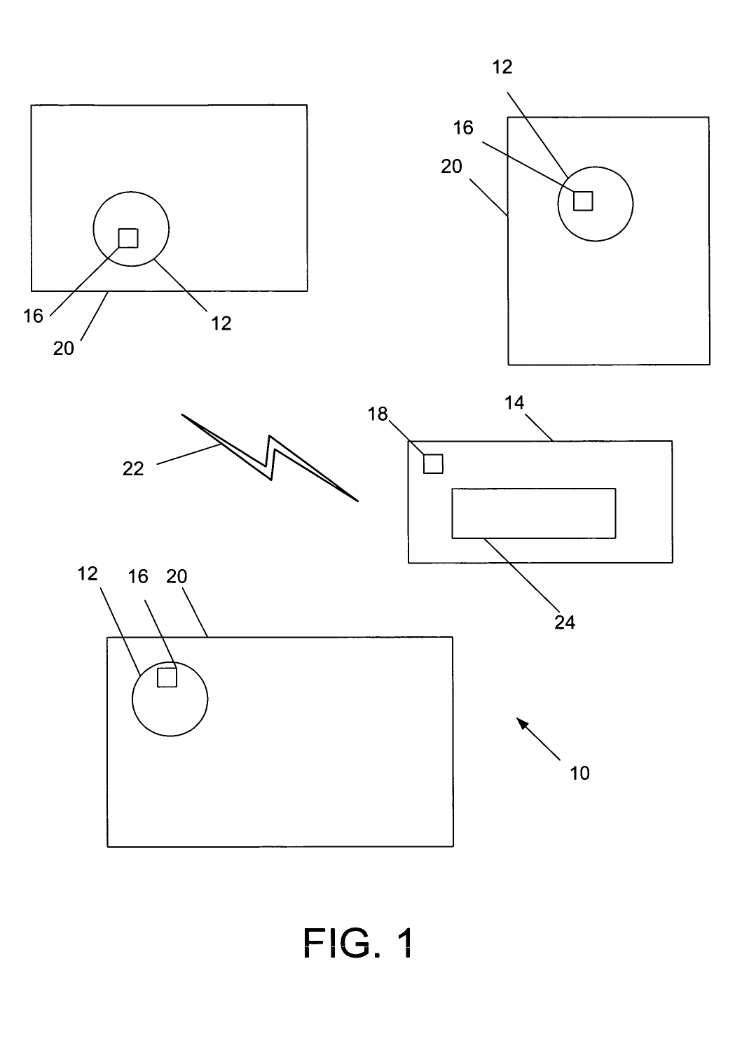

FIG. 1 depicts a functional block diagram of an intrusion warning and reporting network 10 according to one embodiment of the system. Intrusion warning and reporting network 10 includes one or more sensors 12 and a controller 14. Each of the one or more sensors 12 is equipped with a sensor radio 16. Controller 14 is equipped with a controller radio 18. Each sensor of the one or more sensors 12 is placed within a monitor area 20 and communicates with controller 14 via a radio network 22. Controller 14 may comprise a display 24.

In operation, a user will associate the one or more sensors 12 with controller 14 to form radio network 22. The user will place the sensors, either before or after being associated with controller 14, in areas where intrusion detection is desired. Each area where intrusion detection is desired, i.e. monitor area 20, is surveilled by a sensor of the one or more sensors 12. The sensors of the one or more sensors 12 will preferably be disposed within communication range of controller 14. When one of the one or more sensors 12 detects an intrusion, that sensor transmits an appropriate signal to controller 14 via radio network 22. Controller 14, in turn, informs a user visually (via display 24), aurally, and/or haptically of the intrusion.

Display 24 may show details about the intrusion including information regarding the time of the intrusion. Display 24 may also show information regarding the location of the intrusion. For example, details regarding the location of the intrusion may include geographic coordinates. If monitor area 20 is a building, display 24 may show details regarding location that include the building layout, and may further show the specific location of the intrusion within the building layout. Alternatively, if monitor area 20 is an outdoor area, the location information details may include a layout of the outdoor area, and further display the specific location of the intrusion within the specified outdoor area. The location details may include a map display, wherein the location of the intrusion is highlighted on the map display. If the sensor is, or includes, an imaging sensor, recorded visual images may also be transmitted to and shown on display 24.

Radio network 22 may be configured from short-haul radios within each sensor of one or more sensors 12 and controller 14 to form a short-haul communications network. If radio network 22 is a short-haul communications network, it may operate within a range up to approximately 100 meters. As an example, radio network 22 may be a Zig Bee short-haul radio network. However, radio network 22 is not limited to a short-haul network and may comprise a long-haul network. Radio network 22 may also be a short-haul network that is in communication with a long-haul network, allowing for information regarding an intrusion to be sent from controller 14 to a remote monitoring location.

Radio network 22 may also be an ad-hoc network. The ad-hoc network has a flexible architecture to accommodate different types of sensors and to allow for the communication of varying quantities of sensors with controller 14.

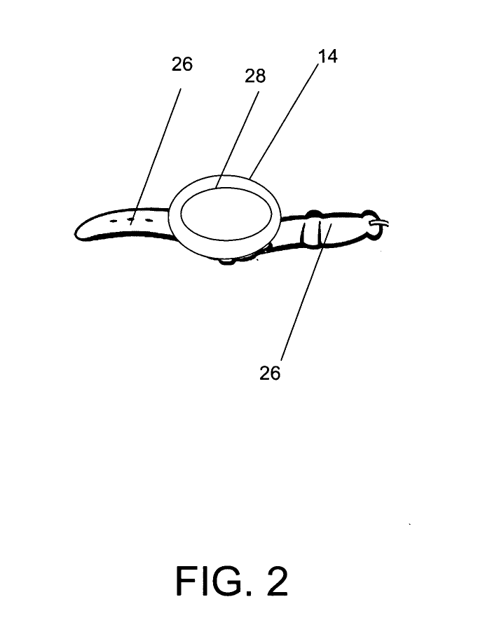

Controller 14 may be implemented in accordance with any one of numerous configurations. In one embodiment, controller 14 may be housed within a computer, such as a laptop or a desktop computer. Alternatively, controller 14 may be a handheld computer, such as a personal digital assistant (“PDA”). Controller 14 may be a ruggedized PDA, (“RPDA”) which comprises a hardened case for rugged and dangerous environments. Controller 14 may be a wearable, wrist-mounted controller. In this embodiment, a user simply attaches controller 14 to his or her wrist with straps 26, as shown in FIG. 2. The user may then view information regarding an intrusion via wrist-mounted controller display 28.

In addition to providing location information, controller 14 may vibrate to alert a user of an intrusion. In this embodiment, a vibration annunciator may be included and the controller may turn on the vibration annunciator to further alert a user that an intrusion has occurred.

The one or more sensors 12 may be infrared motion sensors. Infrared motion sensors detect the movement of the body of a human being or animal by detecting a change of emitted infrared energy from the human or animal. Alternatively, the one or more sensors 12 may be a number of other sensors currently known in the art. Each sensor of the one or more sensors 12 may be further configured to create a noise if an intrusion is detected. A situation in which an alerting noise emanating from a sensor may be desired might be to warn an intruder of a dangerous area, such as if an intruder enters a radioactive zone, for example.

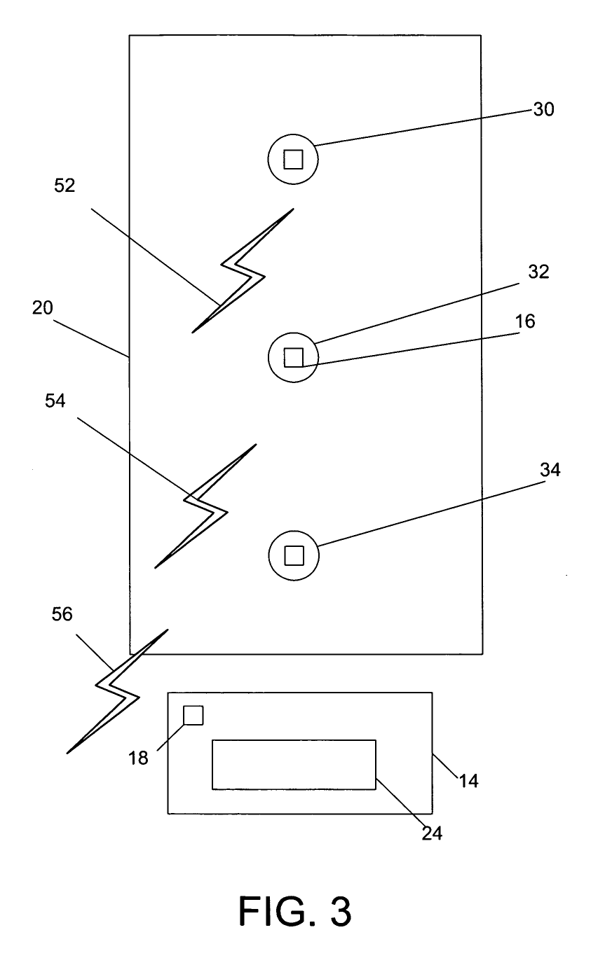

The one or more sensors 12 may be planted in series, as shown in FIG. 3. In this embodiment, a first sensor 30 is linked in communication with a second sensor 32. Second sensor 32 is linked in communication with a third sensor 34. Although FIG. 3 shows only three sensors, many other number configurations of sensors may be used. First sensor 30 communicates over first radio network 52 with second sensor 32. Second sensor 32 communicates over second radio network 54 with third sensor 34, and third sensor 34 communicates over radio network 56 with controller 14. If first sensor 30 detects an intrusion, first sensor 30 may send a signal to second sensor 32, which sends the signal to third sensor 34, and third sensor 34 sends the signal to controller 14. Thus in this embodiment, controller 14 can be up to 300 m away from first sensor 30 yet can still monitor the area surrounding first sensor 30. By setting up these sensors in series, the sensors may communicate with controller 14 over a larger area than any single sensor could reach.

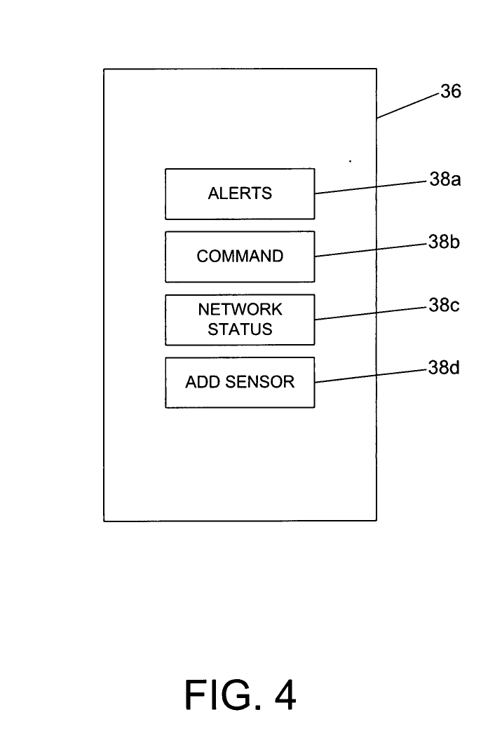

FIG. 4 depicts various functions that may be implemented by controller 14 in the system of FIG. 1. Display 24 may show a control and display screen 36. Control and display screen 36 may show a plurality of screen options 38. Although four screen options are depicted in FIG. 4, control and display screen 36 is not limited to four screen options, and a number of other screen options may be present. A user may select one of the plurality of screen options 38 from control and display screen 36. The plurality of screen options 38 shown in FIG. 4 are an alerts screen 38a, an add sensor screen 38b, a command screen 38c, and a network status screen 38d. Although only these particular screen options are shown, the display is not limited to these specific options and other options may be included or substituted.

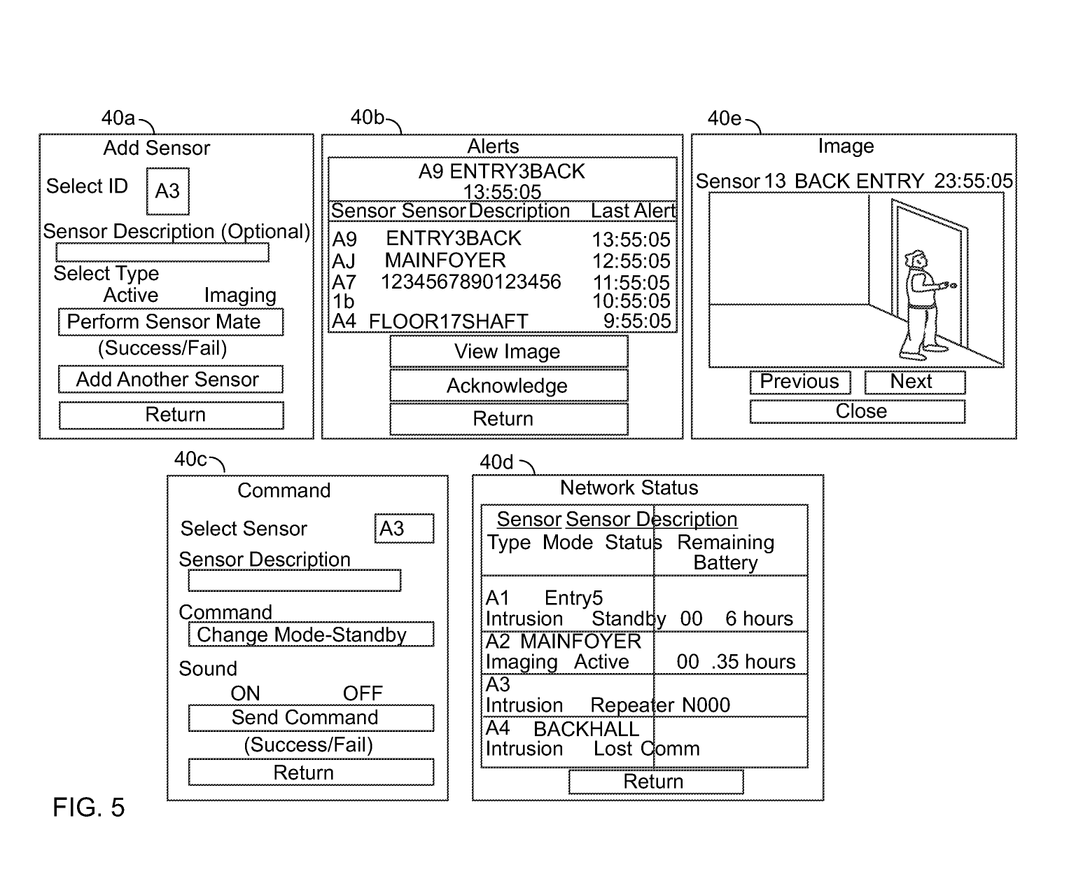

Once a user selects a screen option, a user interface screen 40 will appear on display 24. FIG. 5 depicts various exemplary user interface screens 40 that may be displayed on display 24 of controller 14 of FIG. 4. FIG. 5 shows an add sensor screen 40a, an alerts screen 40b, a command screen 40c, a network status screen 40d, and an image screen 40e. As previously described, add sensor screen 40a, alerts screen 40b, command screen 40c, and network status screen 40d may be selected from control and display screen 36. Image screen 40e may be selected from alerts screen 40b. Alternatively, image screen 40e may be selected from a different

Alerts screen 40b may show information regarding the last intrusion alert and allow a user to further select image screen 40e to view still images or either a recorded or streaming video of an intrusion. Alerts screen 40b may also show or provide access to any of the location information of an intrusion previously discussed.

Add sensor screen 40a allows a user to add more sensors to the network.

Command screen 40c allows a user to change the status of a sensor; a sensor could be set to a number of different modes. For example, the sensor could be either active or inactive, depending on whether that particular area within which the sensor is placed requires surveillance.

Network status screen 40d may provide a user with information regarding the mode set for each sensor, amount of battery remaining in each sensor, as well as the type of sensor.

Although the invention has been described in detail with particular reference to a preferred embodiment, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

We claim:

1. An intrusion detection and reporting system comprising:
at least one sensor for detecting an intrusion; and
a controller in communication with the at least one sensor via a radio network, wherein the controller comprises a display,
wherein in response to detection of an intrusion, the at least one sensor transmits time information and location information regarding the intrusion via the radio network to the controller, and the display shows the time information and location information to a user.

2. The system as in claim 1, wherein the at least one sensor captures an image of the intrusion and transmits the image of the intrusion to the controller.

3. The system as in claim 2, wherein the image of the intrusion is viewable by the user on the display.

4. The system as in claim 1, wherein the location information includes geographic coordinates of a location of the intrusion.

5. The system as in claim 1, wherein the location information includes a layout of a monitored building.

6. The system as in claim 5, wherein the location information includes the location of the intrusion within the layout of the monitored building.

7. The system as in claim 1, wherein the location information includes a layout of an area.

8. The system as in claim 7, wherein the location information includes the location of the intrusion within the layout of the area.

9. The system as in claim 1, wherein the location information includes a map display and a specific location of the intrusion within the map display.

10. The system as in claim 1, further comprising an annunciator, wherein the annunciator comprises a radio which is in communication with the controller, and in response to receiving a signal from the controller over the radio the annunciator vibrates to alert the user of an intrusion.

11. The system as in claim 10, wherein the controller communicates with the annunciator via a wireless communication link.

12. The system as in claim 1, wherein the controller is housed in a wrist-mountable device.

13. The system as in claim 1, wherein the controller is housed in a personal data assistant.

14. The system as in claim 1, wherein the controller is housed in a computer.

15. The system as in claim 1, wherein a first sensor and a second sensor of the at least one sensor are associated in series with the controller.

16. The system as in claim 1, wherein the at least one sensor is an infrared motion sensor.

17. The system as in claim 1, wherein information regarding the intrusion is transmitted from the controller to a remote monitoring location using a long-haul radio.

18. The system as in claim 1, wherein the at least one sensor and the controller are compatible with at least one of: cellular protocol, Bluetooth protocol, Zig Bee protocol.

19. An intrusion detection and reporting network comprising:
at least one sensor; and
a wireless wearable controller adapted to communicate with the at least one sensor, wherein the wireless controller comprises a display screen;
wherein the at least once sensor detects and wirelessly transmits intrusion information, comprising time information and location information of the intrusion, to the controller, and in response to the report, a user may view the intrusion information on the display screen.

20. A method for detecting and reporting an intrusion, comprising:
placing at least one sensor in an monitor area;
detecting an intrusion in the monitor area with the at least one sensor;
transmitting time information and location information about the intrusion from the at least one sensor to a controller via a wireless radio network;
displaying time information and location information concerning the intrusion to a user via a controller display.
